(19) United States
(12) Patent Application Publication
(10) Pub. No.: US 2003/0160105 A1
(43) Pub. Date: Aug. 28, 2003

(54) Methods and apparatus for dispersing a conductive fluent material

(76) Inventor: Arnold J. Kelly, Princeton Junction, NJ (US)

Correspondence Address: LERNER, DAVID, LITTENBERG,, KRUMHOLZ & MENTLIK, 600 SOUTH AVENUE WEST, WESTFIELD, NJ, 07090, US

(21) Appl. No.: 10/081,522

(22) Filed: Feb. 22, 2002

(51) Int. Cl. B05B 5/025

(52) U.S. Cl. 239/3; 239/690; 239/704; 239/708

(57) ABSTRACT

An apparatus for dispersing a fluent material has an initial disperser for breaking a stream of fluent material into discontinuous parts. The apparatus has an electrode supply device that provides free electrons that impart a net charge on the discontinuous parts to disperse the discontinuous parts. A method is also disclosed in which electrons are directed at a flow of droplets of fluent material to disperse the fluent material.

### FIELD OF THE INVENTION

The present invention relates to methods and apparatus for dispersing a fluent material, such as a liquid.

### BACKGROUND OF THE INVENTION

Numerous technical and industrial processes require dispersion of a fluent material. One such dispersion process is atomization of a liquid into droplets. Atomization is employed in industrial processes such as combustion, chemical treatment of liquids, spray coating and spray painting. In certain processes, it is desirable to produce a fine, uniform dispersion of the fluent material. Thus, in atomization of liquids it is desirable to convert the liquid into fine droplets, most desirably droplets of substantially uniform size.

Considerable effort has been devoted to development of methods and apparatus for dispersing fluent materials. For example, mechanical atomizers operate by forcing a liquid to be atomized under high pressure through a fine orifice. Such mechanical atomizers are used in oil burners and as fuel injectors in combustion engines. Other mechanical dispersion devices mix the fluent material to be atomized with a gas flowing at high velocity, so that the fluent material is dispersed by the kinetic effect of the high velocity gas.

Mechanical atomization is utilized for nozzles for spraying water. Fire extinguishing nozzles, for example, utilize a flow of water delivered under pressure to an orifice to produce a high volume spray. Where there is a significant draw on the water pressure of the water system, the pressure can drop to the extent that the nozzle will fail. This is a major concern in fire fighting. Thus, low-pressure water atomization methods are desirable.

A technique known as electrostatic atomization has been employed for dispersing certain types of fluid. In electrostatic atomization, an electrical charge is applied to the fluid, typically as the fluid is discharged from an orifice. Because the various portions of the fluid bear charges of the same polarity, various portions of the fluent material tend to repel one another. This tends to disperse the fluid. Thus, utilizing electrostatic methods, atomization can be achieved at lower flow rates and at lower pressures since the net charge on the fluent material disperses the fluid.

In a rudimentary form of electrostatic atomization, a fluid is discharged from a nozzle towards a counterelectrode. The nozzle is maintained at a substantial electrical potential relative to the counterelectrode and comprises a second electrode. This type of electrostatic atomization is used, for example, in electrostatic spray painting systems. Electrostatic atomization systems of this nature, however, can apply only a small net charge to the fluid to be atomized or the throughput is seriously compromised with a small net charge, the electrostatic atomization effect is minimal.

Certain embodiments of U.S. Pat. No. 4,255,777, the disclosure of which is hereby incorporated by reference herein, disclose a different electrostatic atomization system. In certain embodiments of U.S. Pat. No. 4,255,777, a fluid is passed between a pair of opposed electrodes before discharge through the orifice. Charges leave one of the electrodes and travel towards the opposite electrode through the fluid. The moving fluid tends to carry the charges downstream, towards the discharge orifice. Generally, the velocity of the fluid is great enough that most or all of the charges pass downstream through the orifice and do not reach the opposite electrode. Thus, a net charge is injected into the fluid by the action of the opposed electrodes.

Systems according to embodiments of U.S. Pat. No. 4,255,777 are most effective to disperse fluids which have a relatively low electrical conductivity, typically below about 1 microSiemens per meter. Where the electrical conductivity of the fluid is substantially greater than 1 microSiemens per meter, the charge imparted to the fluid travels to the other electrode before the fluid exits the orifice, so that no net charge, or a very small net charge, is imparted to the fluid. This makes it difficult to maintain a substantial potential difference between the electrodes. For example, water is relatively conductive and not easily dispersed utilizing such atomizers. Typical aqueous solutions of inorganic materials are also highly conductive. These conductive solutions include industrially important material such as water based paints and coatings, comestible materials such as beverage extracts and agricultural materials such as aqueous fertilizer solutions, herbicide solutions and the like.

In certain embodiments of U.S. Pat. No. 5,093,602, the disclosure of which is hereby incorporated by reference herein, an electron gun is utilized to disperse a fluent material. Embodiments of U.S. Pat. No. 5,093,602 are useful for dispersing fluent materials comprising relatively conductive materials. However, the charge imparted to the fluent material tends to flow through the fluent material to the source of fluent material and can short circuit the charge injection process.

Despite these efforts in the prior art, there has been a substantial, unmet need for improved methods and apparatus for dispersing fluent materials.

### SUMMARY OF THE INVENTION

The present invention addresses these needs.

An apparatus for dispersing a fluent material comprises an initial disperser for breaking a stream of fluent material into discontinuous parts so that said discontinuous parts are electrically isolated from a source of the fluent material. An electron supply device is arranged so as to provide free electrons that impart a net negative charge on the discontinuous parts of fluent material so that the discontinuous parts of fluent material are dispersed at least partially under the influence of the net charge. Electrically isolating the discontinuous parts from the source of fluent material reduces the tendency for the charge to travel through the liquid to the source of fluent material. A greater amount of charge remains in the liquid to disperse the liquid into a plume of droplets.

The casing may comprise a conduit for carrying a stream of fluent material. In certain preferred embodiments, the casing has surface profiling that is constructed and arranged in the conduit so as to disrupt the fluent material into discontinuous parts.

In one embodiment, the casing defines an orifice and the conduit terminates at the orifice so that the discontinuous parts of fluent material are produced at the orifice.

In certain embodiments, the electron supply device comprises an electron-permeable membrane having a first side facing the orifice and a second side facing oppositely from the first side. The electron supply device comprises an electron gun arranged on a central axis of the apparatus to provide free electrons at the second side so that the electrons pass through the membrane to the first side and are directed at the discontinuous parts of fluent material at the orifice.

The casing preferably includes a chamber having a first end and a second end. The first end of the casing is open on the conduit at the orifice. A conductive grid is preferably disposed within the chamber adjacent the first side of the membrane. A power supply is connected to the grid to apply an electrical potential to the grid for enhancing the penetration of the electrons to the orifice.

In certain preferred embodiments, the electron supply device comprises an electron emitter arranged on the central axis and having a tip facing the orifice. The casing preferably includes a chamber having a first end and a second end. The first end of the casing is open on the conduit at the orifice, and the tip of the emitter is disposed in the chamber.

In embodiments having a chamber, the pressure within the chamber is preferably decreased utilizing a vacuum pump or by directing the fluent material in a conduit past the first end of the chamber.

The surface profiling may have many shapes. For example, the surface profiling may comprise a plurality of elongated flutes that project into the conduit.

The casing may have many shapes and comprise one or more parts. For example, the casing may comprise a first cylindrical part having a first surface and a second cylindrical part with a second surface. The first cylindrical part is received in the second cylindrical part so that the first surface and the second surface cooperatively define the conduit.

In a further aspect of the present invention, a method of dispersing a fluent material comprising the steps of passing a stream of fluent material over a first surface having profiling to disrupt the stream into discontinuous parts of fluent material. Electrons are directed at the discontinuous parts of the fluent material so as to provide the discontinuous parts of fluent material with a net charge, whereby the fluent material is dispersed at least partially under the influence of the net charge.

The fluent material may comprise a material that is relatively conductive or a material that is relatively nonconductive. In certain embodiments, the fluent material has an electrical resistivity of less than about 1 ohm-meter.

In certain embodiments, the step of directing electrons includes providing free electrons at a second side of an electron-permeable membrane and manipulating the electrons into a beam of electrons so that the electrons pass through the membrane to a first side of the membrane and impinge on the discontinuous parts of fluent material. The discontinuous parts of fluent material are disposed on the first side of the membrane. In certain embodiments, the fluent material is a liquid and the liquid is atomized at least partially under the influence of the net charge. For example, the fluent material may comprise water.

The method may include the step of introducing the stream of fluent material in a rotational flow around the axis, the first surface encircling the axis, to disrupt the stream of fluent material.

Preferably, the method includes the step of providing a low-pressure region having a sub-atmospheric pressure adjacent the stream of fluent material and the electrons are directed through the low-pressure region to the discontinuous parts. The subatmospheric pressure can be anywhere from between about 0 kPa and just under atmospheric pressure. A pressure about 1 kPa is preferred.

Preferably, the charge imparted to the discontinuous parts comprises between about 0.1 and 3 coulombs per meter-cubed.

In a further aspect of the present invention, an apparatus for dispersing a fluent material comprises a casing defining a conduit for passing a stream of fluent material to an orifice defined by the casing. The orifice is disposed on a central axis. The apparatus includes an electron supply device for providing free electrons so that the electrons impinge on the fluent material at the orifice to provide a net charge on the fluent material. The casing has a chamber with an end adjacent the orifice, open on the conduit, and disposed on the central axis. The fluent material is dispersed at least partially under the influence of the net charge.

Preferably, a surface of the casing defining the conduit comprises surface profiling adjacent the orifice for disrupting the stream of fluent material.

The electron supply device may comprise an electrode having an emitter tip facing the orifice or an electron gun.

In another aspect of the present invention, a method of dispersing a fluent material comprises the steps of providing a flow of droplets of fluent material and directing electrons at the droplets of the fluent material so as to provide a net charge on the fluent material and disperse the fluent material under the influence of the net charge.

In preferred embodiments, the step of providing a flow of droplets comprises atomizing a stream of the fluent material to form the droplets. The stream may be atomized by mechanically atomizing the stream of fluent material by delivering the stream of fluent material to an orifice under pressure.

### BRIEF DESCRIPTION OF THE DRAWINGS

These and other features, aspects, and advantages of the present invention will become better understood with regard to the following description, appended claims and accompanying drawings where:

FIG. 1 is a schematic cross-sectional view of an apparatus for dispersing a fluent material in accordance with an embodiment of the invention;

FIG. 2 is a partial, cross-sectional view of the apparatus for dispersing a fluent material in accordance with the embodiment of FIG. 1;

FIG. 3 is a top right perspective view of a fluted surface for the apparatus for dispersing a fluent material in accordance with the embodiment of FIGS. 1-2;

FIG. 4 is the cross-sectional view of FIG. 2 schematically showing fluent material being dispersed;

FIG. 5 is a schematic cross-sectional view of an apparatus for dispersing a fluent material in accordance with another embodiment of the invention; and

FIG. 6 is a schematic view of an apparatus in accordance with a further embodiment of the invention.

### DETAILED DESCRIPTION OF THE PREFERRED EMBODIMENTS

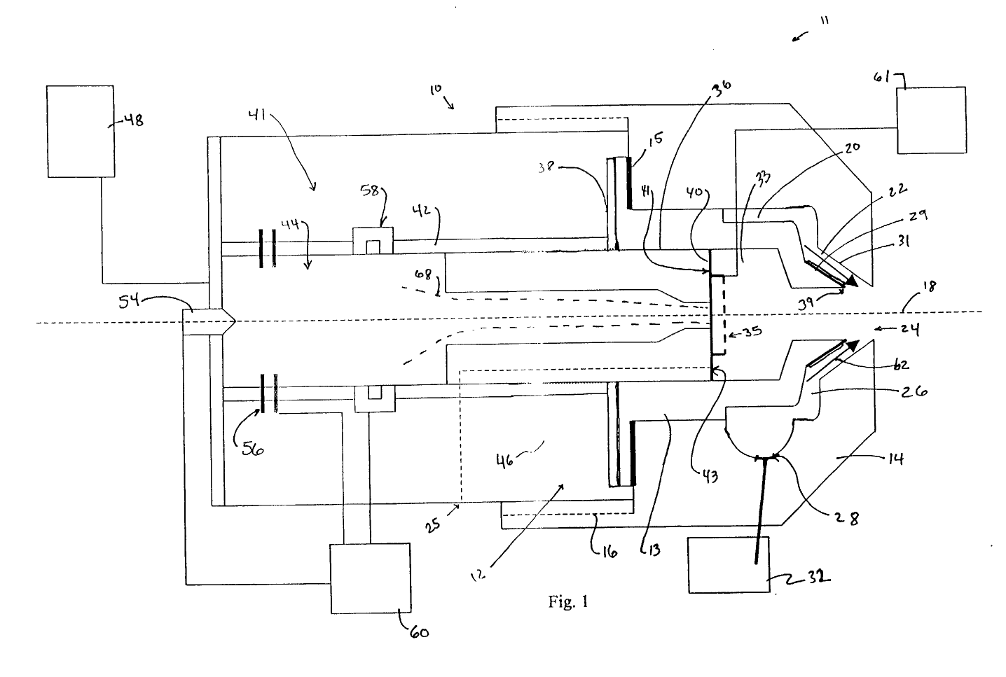

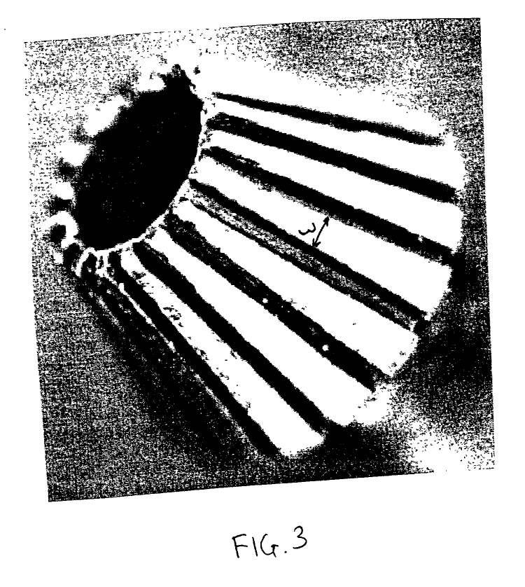

An apparatus in accordance with one embodiment of the present invention is shown in FIGS. 1-4. The apparatus 11 includes a body 10 incorporating a central portion 12 and a cover portion 14. The central portion and cover portion are substantially symmetrical about a central axis 18. The central portion 12 is desirably cylindrical. The cover portion 14 is desirably cylindrical and has a cavity with an open face that receives the central portion within the cavity. The central portion has a central cylinder 13 that is received in the cover portion 14. The cover portion 14 is attached to the central portion 12 by threads 16. The central cylinder 13 has a central surface 29. The cover portion 14 has a cover surface 31 that faces the central surface 29 when the central portion 12 is received in the cover portion 14. These surfaces are shaped so as to cooperatively define a cylindrical space 20 and a generally conical space 22. The cylindrical space 20 and conical space 22 communicate with one another and lead to an orifice 24 formed in the cover portion 14. Spaces 20 and 22 and the orifice 24 are substantially concentric with one another and are centered on axis 18. Spaces 20 and 22 cooperatively define a continuous conduit 26, open on the orifice 24 and terminating at the orifice 24. An inlet opening 28 is provided at an end of the conduit 26 and communicates with the cylindrical space 20. A seal 15 is provided between the central cylinder 13 and cover portion 14 so that when the cover portion 14 is screwed onto the central portion 12, the conduit 26 is sealed. Although the embodiment of FIGS. 1-4 shows a body 10 comprising cylindrical parts, the body may have virtually any shape and may be comprised of one or more parts. In addition, the conical surface 29 shown in FIG. 3 may have a rectangular or triangular shape in cross-section and the conduit 26 may have shapes other than described above.

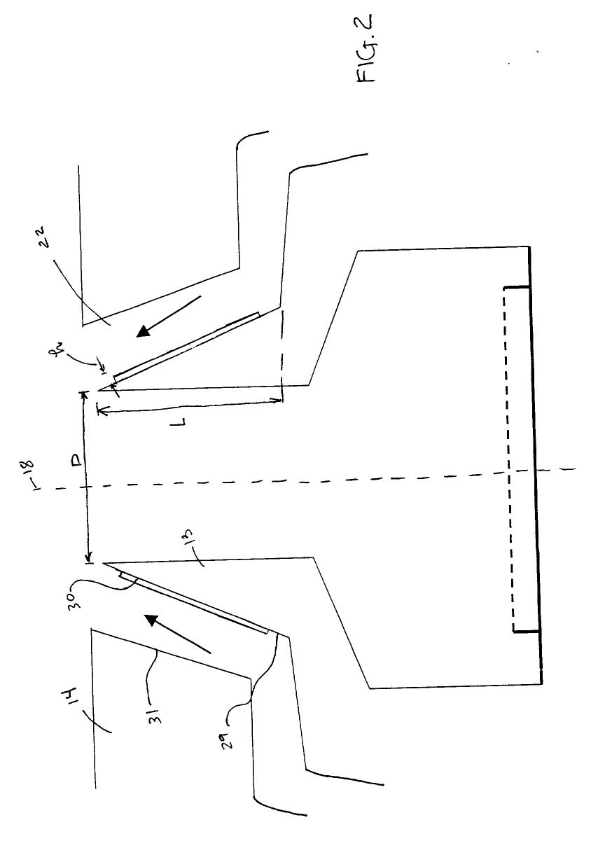

The central surface 29 on the central cylinder 13 carries surface profiling that projects into the conduit 26 and is disposed adjacent the orifice 24. The profiling comprises a set of flutes 30 disposed on the part of the central surface 29 that forms the conical space 22. The flutes 30 are spaced apart circumferentially about central axis 18 and generally extend in a direction substantially parallel to the central axis 18. The flutes 30 are best seen in FIGS. 2 and 3. In one embodiment, the orifice has a 2 millimeter diameter, the conical space 22 formed by the central surface 29 and the cover surface 31 has a length “L” of approximately 3 millimeters and an inner diameter “D” of approximately 2 millimeters. The flutes 30 have a width “W” of approximately 0.15 millimeters and a height “h” of approximately 0.15 millimeters. These dimensions are in no way essential to the invention and the central surface 29 and the conical space 22 may be constructed differently, in embodiments according to the present invention.

The flutes 30 are shown as rectangular elements that protrude from the surface 29 in FIGS. 2 and 3. However, the flutes need not be any particular shape. The flutes may extend in the circumferential direction, wrapping around the cone, in certain embodiments. In addition, profiling comprising raised bumps on the central surface 29 and/or the cover surface 31 could be used. A stippled surface, with indentations could also be used. A textured coating could be applied to the surface 29 and/or surface 31. Any change in the surfaces 29 and/or 31 that would disrupt fluent material moving in the conical space 22 can be used. Furthermore, surface profiling for disrupting the fluent material may be disposed in the cylindrical space 20.

A source of fluent material in this embodiment comprises a tank or other source 32 of a liquid to be atomized. The tank is connected to the inlet 28 such that fluent material is forced from the source 32 into the conduit 26. In the embodiment shown in FIG. 1, the tank 32 is pressurized and is connected to a pipe or pipes having a valve for closing off the fluent material supply. In other embodiments, a pump may be used to deliver the fluent material under pressure to the inlet 28. In certain embodiments, fluent material is delivered to the inlet 28 at a pressure of about 5 to about 15 bar. Preferably, in embodiments having a cylindrically shaped conduit, the inlet 28 is tangentially disposed with respect to the conduit, to impart a rotational flow to the fluent material, further disrupting the fluent material. Preferably, both the inlet and the profiling are disposed so as to achieve this purpose.

The central cylinder 13 has a bore 36 that is coaxial with the central axis 18 and extends through the central cylinder 13 to a first open end 38 of the cylinder. The bore 36 extends to a second open end 39 opposite the first open end 38. The second open end 39 is open to the conduit 26, adjacent the orifice 24. An electron-permeable membrane 40 extends across the bore 36 and is bonded to the central cylinder 13 around the entire periphery of the bore 36. The membrane 40 and central cylinder 13 cooperatively provide an air, gas and liquid impermeable barrier. A first side 41 of membrane 40 faces the first open end 38 and a second side 43 of membrane 40 faces the second open end 39 and the orifice 24. Membrane 40 extends substantially perpendicularly to the central axis 18. Membrane 40 may be formed from boron nitride, beryllium or other known, electron-permeable materials. Most desirably, the membrane 40 has the minimum thickness required to withstand the pressures encountered in service. To permit use of the thinnest possible membranes, it is desirable to minimize the dimensions of the membrane and to minimize the dimensions of the bore 36. Where membrane 40 is formed from boron nitride, its thickness may be on the order of about 2 micrometers to about 10 micrometers, and most typically about 3 micrometers. Preferably, the diameter of the bore 36 is about 2 mm to about 10 mm, and most typically about 6 mm. Where the bore 36 is not circular, the smallest dimension of the bore may be about 2 mm to about 10 mm, and desirably about 6 mm. These preferred ranges apply with respect to unreinforced boron nitride membranes. Membrane 40 may be reinforced by a grid or mesh of reinforcing elements (not shown) covering one or both surfaces of the membrane. In this case, the bore may have greater dimensions, or the membrane 40 may be thinner than specified above.

The membrane 40 forms one side of a chamber 33 disposed on the second side 43 of the membrane 40. The chamber 33 extends to and is open on the second open end 39 of the bore 36 so that the chamber 33 communicates with the conduit 26 and the orifice 24. In preferred embodiments, a conductive grid 35 is disposed in the chamber 33 adjacent the second side 43 of the membrane 40. Preferably, the apparatus 11 includes a pressure monitoring port 25 connected to the chamber 33 and a monitoring device. The port 25 is also connected to a pressure sensor disposed in the port 25. The pressure monitoring device and port are for use in regulating the pressure within the chamber 33.

The apparatus further includes an electron gun assembly 41 having an enclosed electron accelerating tube 42, shown schematically in FIG. 1. The electron gun assembly may be as described in U.S. Pat. No. 5,093,602, the disclosure of which is hereby incorporated by reference herein. Accelerating tube 42 has an interior space 44 and is connected to the central cylinder 13 of body 10 such that the interior space 44 within accelerating tube 42 is in communication with the interior bore 36 of the central cylinder 13. A high vacuum seal 46 is provided at the juncture of tube 42 and central cylinder 13, such that the interior space 44 and bore 36 are effectively isolated from the surrounding atmosphere. The high vacuum seal 46 may comprise an epoxy seal. When tube 44 is first assembled with body 12, the interior space 44 and bore 36 are evacuated by a conventional vacuum pump 48. A chemical substance adapted to react with and consume any atmospheric gases present within space 44 is also provided inside of space 44. Such chemical substances are commonly referred to as “getters” and are well known in the electron tube art. Where the seal 46 between the tube and body is particularly effective, the getter may be omitted. The apparatus 11 may include a vacuum pump 48 that remains connected to the interior space 44, as where there is appreciable leakage into the interior space 44.

Desirably, the interior space within the acceleration tube 42 and the portion of the bore 36 on the first side 41 of the membrane 40 are maintained substantially at a vacuum, i.e., at an internal absolute pressure less than about 10⁻⁶ Torr and desirably less than about 10⁻⁷ Torr. Electron gun assembly 41 is equipped with a conventional cathode 54 and conventional electron accelerating devices such as conductive rings 56 spaced along the length of tube 42. Further, the electron gun assembly 41 includes an electron beam focusing device such as the coil 58 schematically depicted in FIG. 1. These elements are connected to a conventional electrical power source 60 of the type commonly employed for electron beam operations. Power source 60 is arranged to apply a substantial negative electrical potential to cathode 54, and to apply appropriate electrical potentials to rings 56 so that electrons will be discharged from cathode 54 and accelerated away from the cathode by electrostatic potentials applied through rings 56. The power source 60 is arranged to energize coil 58 to provide a focusing magnetic field so as to focus these accelerated electrons into a relatively narrow beam directed substantially along the central axis 18. Merely by example, the power supply for the apparatus shown comprises a 3 kilovolt, 0.5 milliampere, 15 watt (max.), DC power supply and the electrons can be focused into a beam having a diameter of 0.5 millimeters and directed through an orifice having a 2 millimeter diameter. The power source 60 is connected to the cathode 54 for generating electrons in the accelerating tube 42 of the electron gun assembly 41. The power source 60 is also connected to the rings 56 for accelerating the electrons and the coil 58 for focusing the beam of electrons. For example, a voltage of about 25 kilovolts was applied to the rings 56.

The electron gun assembly 41 directs a beam of electrons 68 through the membrane 40 past the conductive grid 35 through the chamber 33 to the orifice 24.

The grid 35 is connected to a power supply 61 to apply a negative voltage to the grid 35. The beam of electrons 68 creates a plasma in the chamber 33, from any materials disposed within the chamber 33. The plasma includes positive ions which tend to absorb the electron beam 68. The grid 35 functions to remove the positive ions in the chamber 33 and enhance the beam 68 generated by the electron gun assembly 41. For example, in the embodiment shown in FIG. 1, a voltage of about −400 volts was applied to the grid 35.

The chamber 33 is maintained at a pressure lower than atmospheric pressure so that the air within the chamber 33 is not so dense as to absorb or significantly interfere with the beam 68 of electrons moving through the chamber to the orifice 24. This will be discussed further below.

In operation, the source of fluent material 32 is connected to the inlet 28 to deliver the fluent material from fluent material source 32 and force the liquid through conduit 26, and through the orifice 24. The fluent material, in this embodiment, comprises an electrically conductive liquid such as water, but in other embodiments may be a substantially non-conductive liquid such as a liquid hydrocarbon. As used in this disclosure with reference to a liquid, the term “conductive” means having an electrical resistivity of less than about 10⁶ ohm-meter. Many conductive liquids have still lower resistivities, typically as low as about 1 ohm-meter or less. The term “non-conductive,” as used with reference to a liquid, means having an electrical resistivity greater than about 10⁶ ohm-meter, and typically greater than about 10⁸ ohm-meter.

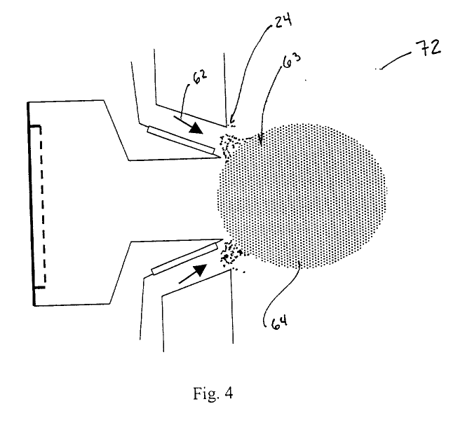

The liquid traveling in the conduit 26 encounters the flutes 30 as the liquid traverses the surface 29 on the central cylinder 13 and approaches the orifice 24. The flutes 30 disrupt the liquid. The stream of disrupted turbulent liquid 62 is schematically represented by arrows in FIGS. 1, 2 and 4. The stream of disrupted liquid 62 enters the orifice 24 and forms a whirling frothy flow 63 just outside the orifice 24. The frothy flow 63 is schematically depicted in FIG. 4. The frothy flow 63 is the stream of liquid 62 broken into discontinuous parts 64. The stream of liquid is initially dispersed by the profiling in the conduit 26. However, other initial dispersers may be used, such as nozzles that direct a spray at the central axis 18.

The discontinuous parts 64 may comprise droplets, elongated globlets and/or vapor. The frothy flow 63 contains a sufficient number of discontinuous parts just outside the orifice 24 so that the frothy flow 63 is electrically separated from the continuous stream of liquid 62 in the conduit 26 that leads to the liquid in the fluent material source 32. Thus, the tendency for the charge to travel through the liquid to the fluent material source, rather than remaining in the liquid to disperse the liquid, is reduced.

The turbulent flow of liquid 62 to the orifice 24 and over the second open end 39 reduces the pressure in the chamber 33 to a sub-atmospheric pressure (1 ATM=101 kPa) so that the electron beam 68 can penetrate the chamber 33 and reach the frothy flow 63 at, or just outside, the orifice 24. In other embodiments, the chamber 33 may be connected to a vacuum pump for reducing the pressure within the chamber. The vacuum pump is preferably connected to the pressure monitoring device within the port 25, for regulating the pressure of the chamber 33 during operation.

While the fluent material flows, electron gun assembly 41, power source 60, and power supply 61 are actuated to provide a beam 68 of electrons. The beam 68 is directed by focusing coil 58 through electron-permeable membrane 40 and hence into the orifice 24 through the second open end 39. The electrons in beam 68 pass from the second open end 39 generally parallel to the central axis 18, towards the orifice 24 and the frothy flow 63. As best appreciated with reference to FIG. 4, the electrons in beam 68 impinge upon the frothy flow 63 just outside the orifice 24. The electron beam imparts a negative net charge to the discontinuous parts 64 of the fluent material. As the negatively charged portions of the liquid tend to repel one another, the frothy flow 63 disperses into a large plume of droplets 72. Although FIG. 4 shows the plume 72 superimposed on the frothy flow 63, the discontinuous parts 64 are further broken up, into the plume of droplets 72 by the beam 68 of electrons. The atomization process may be assisted by mechanical action of the liquid passing over the flutes 30 and through the orifice 24. Thus, the frothy flow 63 comprises fluent material that is to some extent fragmented even in the absence of the electron beam. However, the atomization process is materially enhanced by the negative charges applied by the electron beam. A plume of droplets 72 is generated without utilizing the higher pressures that would be required if mechanical atomization were relied upon.

A continuous flow of conductive liquid tends to dissipate the charge applied to the liquid by the electron beam 68 by conduction of the charge to the source of liquid and to ground. Without committing to a theory of operation, the discontinuous parts 64 in the frothy flow 63 are electrically isolated from the stream of liquid 62 so that substantially less of the charge applied by the electron beam 68 tends to flow through the liquid stream 62 to the liquid source 32 and the nearest available ground. Charge reaching the frothy flow 63 is denied a continuous pathway back to the grounded liquid supply 32 and is trapped in the discontinuous parts 64 of liquid. The liquid is atomized into the plume 72 under the influence of the net charge imparted to the discontinuous parts 64.

Preferably, the body 10 is formed from an electrically insulating material or else is substantially electrically isolated from ground. Liquid source 32 may be isolated from an electrical ground, so that as the system operates, the liquid source, the conduits connecting them to the inlet 28; and the liquid within them assume a net negative charge. Alternatively, the conduits connecting the liquid source 32 to the inlet 28 may be formed from an insulating material, and may have a relatively small cross section and a relatively substantial length, so that the only electrical pathway from the nozzle to the liquid source is a high impedance pathway through the liquid column in the conduits. This arrangement minimizes undesired current flow away from the frothy fluent material 63 at the orifice 24 that may occur during operation of the device. In a preferred embodiment, the interior surface of the chamber 33 is insulated, or coated with an insulating material, such as a diamond coating, for reducing conduction of electrical charge from the electron beam 68 through the body of the device.

The apparatus and methods discussed above may be employed using a wide variety of fluent materials. In particular, both conductive and non-conductive liquids may be atomized. Substantially the same apparatus and methods can be used to treat fluent materials incorporating a solid phase, such as a fluent powder or a suspension of a solid in a liquid or gas. In this case, the individual particles of the solid may be charged by exposure to the electron beam, and hence may be dispersed by processes including a mutual repulsion of the charged particles. Typically, the shape and size of the conduit 26 in body 10 would be selected to accommodate a flow of the solid particulate material without binding or jamming, and the solid particles of material would be fed by an appropriate feeding device such as a vibratory feeder, ram or the like. Processes according to this aspect of the invention provide a dispersion of the solid particle material in the surrounding atmosphere, rather than atomization of a liquid. As used herein, the term “a dispersion” and the “dispersing” should be understood broadly, as encompassing both dispersion of a solid particle material and atomization of a liquid material. Among other uses, dispersed solid particles are used in pharmaceutical preparation and in application of coatings to various articles.

The liquid droplets or dispersed solids provided at or the outside the orifice may be employed in substantially the same way as liquid droplets created by conventional nozzles. Thus, liquid droplets resulting from the process may be blended with a gas, as in a combustion process or in creation of a fog, mist or vapor. The droplets may also impinge on a solid substrate, such as a workpiece to be coated with the liquid. The substrate (not shown) may be grounded or may be maintained at a positive potential relative to ground so as to attract the negatively charged droplets. Likewise, where fluent solid material is dispersed, the same may be applied to a solid substrate, and the solid substrate may be positively charged to attract the solid particles.

In the apparatus and methods discussed above, the stream of electrically charged fluent material passes from the orifice into the atmosphere. In certain circumstances the methods and apparatus disclosed in U.S. Pat. No. 4,605,485, the disclosure of which is hereby incorporated by reference herein, may be used to address corona breakdown in the atmosphere downstream of the orifice. A dielectric gaseous stream may be provided by a separate, annular orifice surrounding the discharge orifice of an electrostatic atomization device, for example. Conversely, as disclosed in certain embodiments of U.S. Pat. No. 4,630,169, the disclosure of which is hereby incorporated by reference herein, the inert gas blanket may be provided by adding a volatile dielectric liquid to the fluent material to be atomized prior to discharge of the fluent material through the discharge orifice, so that the dielectric gas blanket is formed by vapors of the volatile liquid.

In certain circumstances, the measures disclosed in certain embodiments of copending, commonly assigned U.S. Pat. No. 4,991,774 and issued Feb. 12, 1991 as U.S. Pat. No. 4,991,774 may also be employed. The disclosure of said U.S. Pat. No. 4,991,774 is hereby incorporated by reference herein. In certain circumstances, corona breakdown may occur at the orifice. The methods and apparatus disclosed in certain embodiments of U.S. Pat. Nos. 6,206,307 and 6,227,465, the disclosures of which are hereby incorporated by reference herein may be used.

The apparatus according to the present invention typically is operated to discharge the stream of fluent material to be dispersed into a surrounding atmosphere which is at an atmospheric pressure of about 100 kPa absolute pressure. The pressure of the fluent material within the conduit 26 will depend upon the factors such as the flow rate of the fluent material, its viscosity or resistance to flow and the dimensions of the conduit and orifice 24 and the pressure within the fluent material source 32. Typically, however, the fluent material is under atmospheric or superatmospheric pressures. As discussed above, the electron-permeable membrane 40 effectively isolates the interior space 44 within the electron gun chamber from these high fluid pressures and hence permits acceleration and focusing of the electron beam substantially in a vacuum.

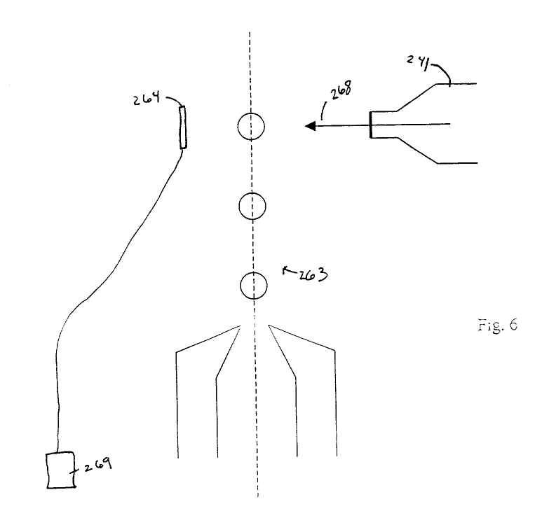

In other embodiments, the discontinuous parts of fluent material comprise a stream of droplets 263 that is generated and directed towards an electron beam 268. In the embodiment shown in FIG. 6, the path of the electron beam 268 intercepts the path of the stream of droplets 263. The stream of droplets 263 is generated utilizing mechanical atomization, electrostatic atomization or other methods. For example, the fluent material may be disposed in a capillary and emerge from the open end of the capillary as droplets that are allowed to fall so as to be intercepted by an electron beam 268. The electron beam 268 is generated by an electron gun assembly 241, substantially as described above. The entire arrangement is disposed so that the electron beam 268 reaches the stream of droplets 263 before the beam is substantially absorbed in any surrounding medium. For example, an electrode 264 is disposed on an opposite side of the stream of droplets 263 from the gun assembly 241. The electrode may comprise an electrode connected to a high voltage power source 269. In other embodiments, the gun assembly is arranged to direct the electron beam 268 towards a grounded electrode. Thus, a fluent material that is partially fragmented into discontinuous parts may be converted into a plume of atomized fluent material utilizing the present invention.

As these and other variations and combinations of the features discussed above can be utilized, the foregoing description of the preferred embodiment and the following example should be taken by way of illustration rather than by way of limitation of the invention as defined by the claims.

### EXPERIMENTAL EXAMPLE OF A PREFERRED EMBODIMENT

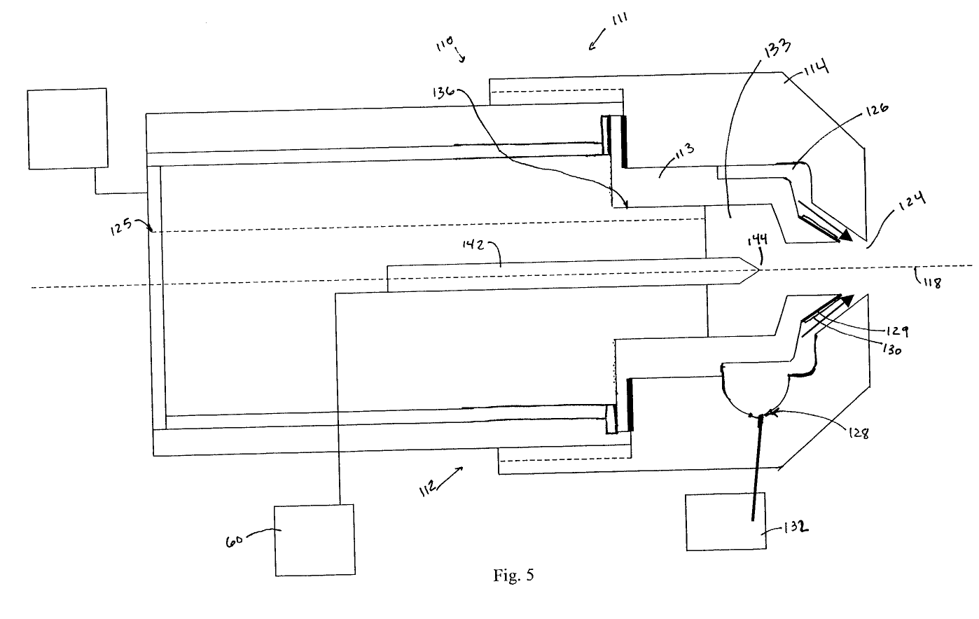

A further embodiment of the invention is shown in FIG. 5. FIG. 5 shows an apparatus 111 substantially as shown in FIG. 1 and as discussed above. However, in the apparatus of FIG. 5, the electron supply device comprises a single emitter 142 mounted within the bore 136 of a central cylinder 113 of the body 110. The apparatus 111 may be as disclosed in certain embodiments of U.S. Pat. No. 4,255,777, the disclosure of which is hereby incorporated by reference herein. In the example shown in FIG. 5, the emitter 142 comprises a 0.5 millimeter diameter carbon steel needle. The apparatus 111 has a central portion 112 and cover portion 114 that cooperatively define a conduit 126 for delivering fluent material to the orifice 124 formed in the cover portion 114. A surface 129 on the central cylinder 113 has flutes 130 for disrupting a stream of fluent material moving within the conduit 126. The conduit 126 leads from a fluent material supply inlet 128 to the orifice 124, which is located on a central axis 118 of the apparatus 111. A source of fluent material 132 is connected to the inlet 128 for delivering fluent material to the apparatus 111.

The apparatus 111 has a chamber 133 that extends along the central axis 118 to the orifice 124. The chamber 133 is open on the orifice 124 and the conduit 126.

The emitter 142 is mounted within the bore 136 of the central cylinder 113 so that the tip 144 of the emitter is disposed within the chamber 133. The emitter is connected to a power source 60. A pressure monitoring port 125 is connected to the chamber 133 for measuring the pressure within the chamber 133 during operation of the apparatus 111.

The device shown in FIG. 5 was operated with a Bertan model 230 3 kilovolt, 5 microamp, DC power supply power supply. The device 111 was connected to a tap water supply as the source of fluent material 132. The tap water feed pressure was 1113 kilopascals (about 11 bar). The pressure within the chamber 133 was 54 kilopascals. At the maximum power setting of 5 watts, the spray current was 13 milliamperes. During operation on the order of 1 kilovolt, charging level of the water on the order of 0.2 coulombs per meter cubed was achieved. The apparatus 111 successfully dispersed the water into a plume of droplets.

These results can be extrapolated to 60 microamperes of spray current. The apparatus 111 would operate at just over 3 kilovolts using 75 watts of power.

1. Apparatus for dispersing a fluent material comprising:
(a) an initial disperser for breaking a stream of fluent material into discontinuous parts so that said discontinuous parts are electrically isolated from a source of said fluent material; and
(b) an electron supply device is arranged so as to provide free electrons that impart a net charge on said discontinuous parts of fluent material so that said discontinuous parts of fluent material are dispersed at least partially under the influence of said net charge.

2. The apparatus of claim 1, wherein said initial disperser comprises a casing defining a conduit for carrying the stream of fluent material.

3. The apparatus of claim 2, wherein the said casing has surface profiling that is constructed and arranged in said conduit so as to disrupt said fluent material into the discontinuous parts.

4. The apparatus of claim 3, wherein said casing defines an orifice and said conduit terminates at said orifice so that said discontinuous parts of fluent material are produced at said orifice.

5. The apparatus of claim 4, wherein said electron supply device is aligned with said orifice on a central axis for said casing.

6. Apparatus of claim 5, wherein said conduit has a cylindrical shape so as to project said fluent material in a stream around said central axis towards said orifice.

7. The apparatus of claim 5, wherein said electron supply device comprises an electron-permeable membrane having a first side facing said orifice and a second side facing oppositely from said first side, said electron supply device comprising an electron gun being arranged on said central axis to provide free electrons at said second side so that the electrons pass through said membrane to said first side and are directed at said discontinuous parts of fluent material at said orifice.

8. The apparatus of claim 7, wherein said casing includes a chamber having a first end and a second end, said first end being open on said conduit at said orifice.

9. The apparatus of claim 8, further comprising a conductive grid disposed within said chamber adjacent said first side of said membrane and a power supply connected to said grid to apply an electrical potential to said grid for enhancing the penetration of said electrons to said orifice.

10. The apparatus of claim 5, wherein said electron supply device comprises an electron emitter arranged on said central axis and having a tip facing said orifice.

11. Apparatus as claimed in claim 10, wherein said emitter comprises a ½ millimeter diameter carbon steel needle.

12. The apparatus of claim 10, wherein said casing includes a chamber having a first end and a second end, said first end being open on said conduit at said orifice, and said tip of said emitter being disposed in said chamber.

13. The apparatus of claim 8 or 12, further comprising a vacuum pump connected to said chamber for decreasing the pressure within said chamber.

14. The apparatus of claim 8 or 12, wherein said conduit directs said fluent material past said first end so that the pressure within said chamber is decreased.

15. The apparatus of claim 3, wherein said surface profiling comprises a plurality of elongated flutes that project into said conduit.

16. Apparatus of claim 15, wherein said conduit has a conical shape and said flutes are generally extended in a substantially parallel to the central axis.

17. The apparatus of claim 3, further comprising a source of fluent material.

18. The apparatus of claim 17, wherein said conduit has an inlet and said source of fluent material comprises a tank delivering fluent material to said inlet at a pressure of between about 5 and about 15 bar.

19. The apparatus of claim 3, wherein said casing comprises a first cylindrical part having a first surface and a second cylindrical part with a second surface, said first cylindrical part being received in said second cylindrical part so that said first surface and said second surface cooperatively define said conduit.

20. The apparatus of claim 19, wherein said surface profiling is disposed on said first surface.

21. Apparatus as claimed in claim 8, further comprising a first power source connected to aid electron supply device, a conductive grid disposed adjacent said first side of said membrane, and a second power source connected to said grid.

22. A method of dispersing a fluent material comprising the steps of:
providing a flow of droplets of fluent material; and
directing electrons at said droplets of said fluent material so as to provide a net charge on said fluent material and disperse said fluent material under the influence of said net charge.

23. Method as claimed in claim 22, wherein the step of providing a flow of droplets comprises atomizing a stream of said fluent material to form said droplets.

24. Method as claimed in claim 22, wherein the step of atomizing said stream of fluent material comprises mechanically atomizing said stream of fluent material by delivering said stream of fluent material to an orifice under pressure.

25. The method of claim 22, wherein the step of providing a flow of droplets comprises passing a stream of fluent material over a first surface having profiling to disrupt said stream into discontinuous parts of fluent material and the step of directing electrons comprises directing electrons at said discontinuous parts of said fluent material.

26. Method of claim 22, wherein said fluent material has an electrical resistivity of less than about 1 ohm-meter.

27. Method of claim 25, wherein
a) the step of directing electrons includes providing free electrons at a second side of an electron-permeable membrane and manipulating said electrons into a beam of electrons so that the electrons pass through the membrane to a first side of said membrane and impinge on said discontinuous parts of fluent material, said discontinuous parts of fluent material being disposed on said first side of said membrane.

28. Method of claim 25, wherein said step of passing a stream of fluent material includes directing said fluent material through a conduit, said conduit being defined by said first surface and a second surface having an orifice defined therein, wherein said electrons are directed along an axis, said orifice being disposed on said axis.

29. Method of claim 26, wherein said profiling is located adjacent said orifice and said stream is directed over said profiling and towards said orifice so that said stream breaks into said discontinuous parts at said orifice.

30. A method of claim 25, wherein said fluent material is a liquid and said liquid is atomized at least partially under the influence of said net charge.

31. Method of claim 30, wherein said fluent material comprises water.

32. Method of claim 28, further comprising the step of introducing said stream of fluent material in a rotational flow around said axis, said first surface encircling said axis, to disrupt said stream of fluent material.

33. The method of claim 25, further comprising providing a low-pressure region having a sub-atmospheric pressure adjacent the stream of fluent material, said electrons being directed through said low-pressure region to said discontinuous parts.

34. The method of claim 33, wherein the subatmospheric pressure comprises between about 10 and 80 kPa.

35. The method of claim 25, wherein the charge imparted to the discontinuous parts comprises between about 0.1 and 3 coulombs per meter-cubed.

36. Apparatus for dispersing a fluent material comprising:
a) a casing defining a conduit for passing a stream of fluent material to an orifice defined by said casing, said orifice being disposed on a central axis; and
b) an electron supply device for providing free electrons so that the electrons impinge on the fluent material at said orifice to provide a net charge on the fluent material, the fluent material being dispersed at least partially under the influence of said net charge,
c) said casing having a chamber with an end adjacent said orifice, open on said conduit, and disposed on said central axis.

37. Apparatus of claim 36, further comprising a source of fluent material and wherein said conduit has an inlet and said source of fluent material comprises a tank delivering fluent material to said inlet at a pressure of between about 5 to about 15 bar.

38. Apparatus of claim 36, wherein a surface of said casing defining said conduit comprises surface profiling adjacent said orifice for disrupting said stream of fluent material.

39. Apparatus as claimed in claim 36, wherein said chamber has a pressure of between about 1 kilopascal and 80 kilopascals.

40. Apparatus as claimed in claim 36, wherein said electron supply device comprises an electrode having an emitter tip facing said orifice.

41. Apparatus as claimed in claim 36, wherein said electron supply device comprises an electron gun.

42. Apparatus as claimed in claim 36, wherein said chamber is defined by a surface of said casing, said surface comprising an insulating material.
